(19) United States
(12) Patent Application Publication
(10) Pub. No.: US 2021/0114227 A1
(43) Pub. Date: Apr. 22, 2021

(54) ROBOT AND METHOD FOR OPERATING ROBOT

(71) Applicant: KAWASAKI JUKOGYO KABUSHIKI KAISHA, Kobe-shi, Hyogo (JP)

(72) Inventor: Kazunori HIRATA, Yao-shi (JP)

(73) Assignee: KAWASAKI JUKOGYO KABUSHIKI KAISHA, Kobe-shi, Hyogo (JP)

(21) Appl. No.: 16/494,631

(22) PCT Filed: Mar. 16, 2018
(86) PCT No.: PCT/JP2018/010439

§ 371 Date: Sep. 16, 2019

(30) Foreign Application Priority Data
Mar. 16, 2017 (JP) 2017-051457

(51) Int. Cl. B25J 11/00; B25J 15/00; B25J 15/10; B25J 9/00; B25J 9/04; A21C 9/02

(52) U.S. Cl. CPC B25J 11/0045; B25J 15/0014; B25J 15/106; B25J 9/043; B25J 9/044; A21C 9/02; B25J 9/0087

(57) ABSTRACT

A robot for transporting long and flexible food to a predetermined position, which includes: a base, a first and a second robot arm which are connected to the base, a robot hand provided to the first robot arm and configured to hold the food, an end effector provided to the second robot arm, and a control device configured to control an operation of the first robot arm and the second robot arm. The end effector is configured to support a longitudinal intermediate portion of the food in a state where the food is hung down from an end portion of the robot hand, and the control device controls the operation of the first robot arm and the second robot arm to transport the food in a state where the food is held by the robot hand and the longitudinal intermediate portion of the food is supported by the end effector.

### TECHNICAL FIELD

The present invention relates to a robot and a method for operating a robot.

### BACKGROUND ART

In a production site of long and flexible food such as pasta, workers grab the food only in an optimal amount by hand and dish the food. In recent years, in various fields, it has been proposed that robots and workers work together in the same work space from the viewpoint of productivity improvement. In the production site of the food as described above, in a case where a humanoid work robot is introduced, measures for the robot to securely hold and transport food are necessary. In the related art, there has been a robot that transfers food consisting of noodle strings such as udon, soba, and ramen (refer to PTL 1 and PTL 2).

### CITATION LIST

### Patent Literature

PTL 1: Japanese Patent No. 5477665

PTL 2: Japanese Patent No. 2788302

### SUMMARY OF INVENTION

### Technical Problem

However, in a case where the food is held by robot hands of PTL 1 and PTL 2 in the related art, since the food is long and flexible, the food is in a state of being hung down from end portions of the robot hands. Ina case where, in such a state, the food is transported to a predetermined position, there is a possibility that the food comes in contact with other devices or nearby workers or part of the food falls halfway.

The present invention is made to solve the above-described problems, and an object of the present invention is to securely transport long and flexible food such as pasta to a predetermined position.

### Solution to Problem

In order to achieve the above-described object, a robot according to an aspect of the present invention is a robot for transporting food which is long and flexible to a predetermined position. The robot includes a base, a first robot arm and a second robot arm which are connected to the base, a robot hand provided to the first robot arm and configured to hold the food, and an end effector provided to the second robot arm, in which the end effector is configured to support a longitudinal intermediate portion of the food in a state where the food is hung down from an end portion of the robot hand, and the food is transported in a state where the food is held by the robot hand and the longitudinal intermediate portion of the food is supported by the end effector.

With the above configuration, in a state where food (for example, pasta) held by the robot hand of one robot arm is hung down from the end portion of the robot hand, the longitudinal intermediate portion of the food can be supported by the end effector of the other robot arm. In this manner, it is possible to transport the food after reducing the dimension of the total length of the food in an up and down direction. In the transportation operation, a movement amount of the robot arm on the robot hand side in the up and down direction becomes small, and accordingly, it is suitable for a SCARA robot having a short stroke in the up and down direction, for example.

The end effector may have a rod-shaped distal end portion extending in a horizontal direction in a posture of at least one robot, and the rod-shaped distal end portion may be operated to cross the longitudinal intermediate portion of the food hung down from the end portion of the robot hand.

With the above configuration, since the rod-shaped distal end portion of the end effector extends in the horizontal direction, it is possible to support the longitudinal intermediate portion of the food by the distal end portion of the end effector by causing the distal end portion to be operated to cross the longitudinal intermediate portion of the food hung down from the end portion of the robot hand.

Alternatively, the end effector may have a flat-plate-shaped distal end portion extending in a horizontal plane in a posture of at least one robot, and the flat-plate-shaped distal end portion may be operated to cross the longitudinal intermediate portion of the food hung down from the end portion of the robot hand.

With the above configuration, since the flat-plate-shaped distal end portion of the end effector extends in the horizontal plane, it is possible to support the longitudinal intermediate portion of the food by the distal end portion of the end effector by causing the distal end portion to be operated to cross the longitudinal intermediate portion of the food hung down from the end portion of the robot hand.

Alternatively, the end effector may have a U-shaped or V-shaped distal end portion in plan view in a posture of at least one robot, and the U-shaped or V-shaped distal end portion is operated to cross the longitudinal intermediate portion of the food hung down from the end portion of the robot hand.

With the above configuration, since the distal end portion of the end effector has a U-shape or V-shape, it is possible to support the longitudinal intermediate portion of the food by the distal end portion of the end effector by causing the distal end portion to be operated to cross the longitudinal intermediate portion of the food hung down from the end portion of the robot hand. In addition, it is easy to align the position of the end effector with the center of the food. The U-shape or V-shape may be a notch.

Alternatively, the end effector may have a spoon-shaped distal end portion provided with a recess, and in a state where an opening of the recess is directed upward in a posture of at least one robot, the spoon-shaped distal end portion may be operated to cross the longitudinal intermediate portion of the food hung down from the end portion of the robot hand.

With the above configuration, since the distal end portion of the end effector has a spoon shape, it is possible to support the longitudinal intermediate portion of the food by the recess of the spoon by causing the distal end portion to be operated to cross the longitudinal intermediate portion of the food hung down from the end portion of the robot hand in a state where the opening of the recess is directed upward. In addition, pasta may be transported after being gathered by being rotated on a plate as a person rotates pasta on a spoon by using a fork.

The robot hand may include a plurality of fingers configured to hold the food by an interval between lower distal ends being closed, and an opening/closing driving device configured to operate the plurality of fingers in a holding direction and an opening direction which is a direction opposite to the holding direction, a food loosening operation of opening the plurality of fingers and dropping the food may be performed after the food is held by the plurality of fingers, and the food may be transported after the food loosening operation.

With the above configuration, an operation of picking up and dropping, for example, pasta is repeatedly performed, and thereby the pasta can be loosened. The flexibility of the pasta is increased, and thus it becomes easy to hold the pasta.

The robot hand may be lowered after a holding operation of the food, and then may be suddenly stopped. With the above configuration, an excessive amount of pasta is shaken off, and thus an appropriate amount of pasta can be held.

A method for operating a robot according to another aspect of the present invention is a method for operating a robot including a base, a first robot arm and a second robot arm which are connected to the base, a robot hand provided to the first robot arm and configured to hold the food, and an end effector provided to the second robot arm. The method includes holding food which is long and flexible by the robot hand, supporting a longitudinal intermediate portion of the food in a state where the food is hung down from an end portion of the robot hand, by the end effector, and transporting the food to a predetermined position in a state where the food is held by the robot hand and the longitudinal intermediate portion of the food is supported by the end effector.

### Advantageous Effects of Invention

The present invention has the above-described configurations, and can securely transport long and flexible food such as pasta to a predetermined position.

### BRIEF DESCRIPTION OF DRAWINGS

FIG. 1 is a perspective view illustrating an overall configuration of a robot according to an embodiment of the present invention.

FIG. 2 is a front view schematically illustrating an overall configuration of an example of the robot of FIG. 1.

FIG. 3 is a view illustrating a configuration of an end effector (robot hand) of FIG. 2.

FIG. 4 is a view illustrating a configuration of the end effector of FIG. 2.

FIG. 5 is a functional block diagram schematically illustrating a configuration of a control device.

FIG. 6 is a flowchart illustrating an operational procedure of the robot.

FIG. 7 is a schematic view illustrating an example of an operation of the robot.

FIG. 8 is a schematic view illustrating an example of the operation of the robot.

FIG. 9 is a view illustrating a configuration of an end effector according to a first modification example.

FIG. 10 is a view illustrating a configuration of an end effector according to a second modification example.

FIG. 11 is a view illustrating a configuration of an end effector according to a third modification example.

FIG. 12 is a view illustrating a configuration of an end effector according to a fourth modification example.

### DESCRIPTION OF EMBODIMENTS

Hereinafter, preferred embodiments will be described with reference to the drawings. In the following, the same or corresponding elements are denoted by the same reference numerals in all of the drawings, and the redundant description thereof will be omitted. In addition, the drawings schematically illustrate the respective constituent elements in order to facilitate understanding.

### Embodiments

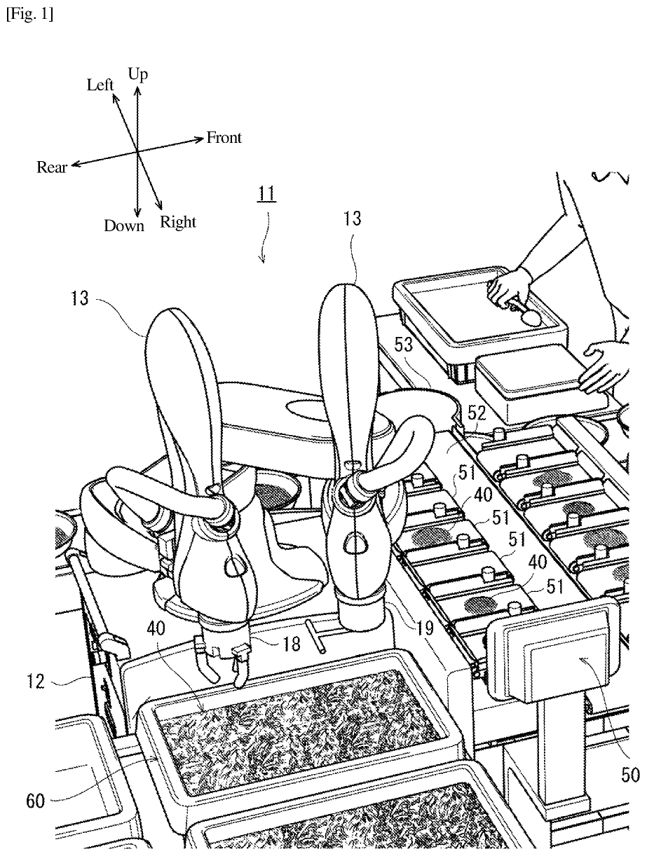

FIG. 1 is a perspective view illustrating an overall configuration of a robot according to an embodiment of the present invention. As illustrated in FIG. 1, a robot 11 is a double arm robot that includes a pair of robot arms (hereinafter, simply described as “arm” in some cases) 13, 13 supported by a base 12. Hereinafter, a direction in which a pair of arms is extended is referred to as a right and left direction, a direction parallel to a shaft center of a base shaft is referred to as an up and down direction, and a direction orthogonal to the right and left direction and the up and down direction is referred to as a front and rear direction. The robot 11 is applied to a production site of food 40. In the present embodiment, the food 40 is pasta. Here, an aggregate of noodle strings of long and flexible pasta is collectively referred to as the food 40. The robot 11 is an apparatus for transporting the food 40 to a predetermined position. The robot 11 can be installed in a limited space (for example, 610 mm×620 mm) corresponding to one person. A large tray container 60 is disposed on the right side of the robot 11. The tray container 60 is opened upwardly, and a large amount of food 40 is accommodated in the inside of the tray container 60. A combination weighing device 50 for the food 40 is disposed in front of the robot 11. The combination weighing device 50 includes a plurality of weighing conveyors 51 and a transporting conveyor 52, which are disposed on a table in front of the robot 11. The robot 11 holds a predetermined amount (for example, an amount corresponding to one serving) of the food 40 from the tray container 60 by the end effector (18) connected to each of the arms 13, 13 and transports the food 40 to a predetermined position on the weighing conveyor 51. The weighing conveyor 51 measures a weight of the food 40 disposed on a belt, and then sends the food 40 on the belt to the transporting conveyor 52 by the rotation of the belt. The transporting conveyor 52 sends the food 40 which is sent from each weighing conveyor 51 to a food supply port 53 at a predetermined interval. A worker performs a dishing work of the food 40 supplied from the food supply port 53. In the present embodiment, a work area of the pair of arms 13, 13 covers the tray container 60 disposed on the right side of the robot 11 and the entirety of the combination weighing device 50 disposed in front of the robot 11.

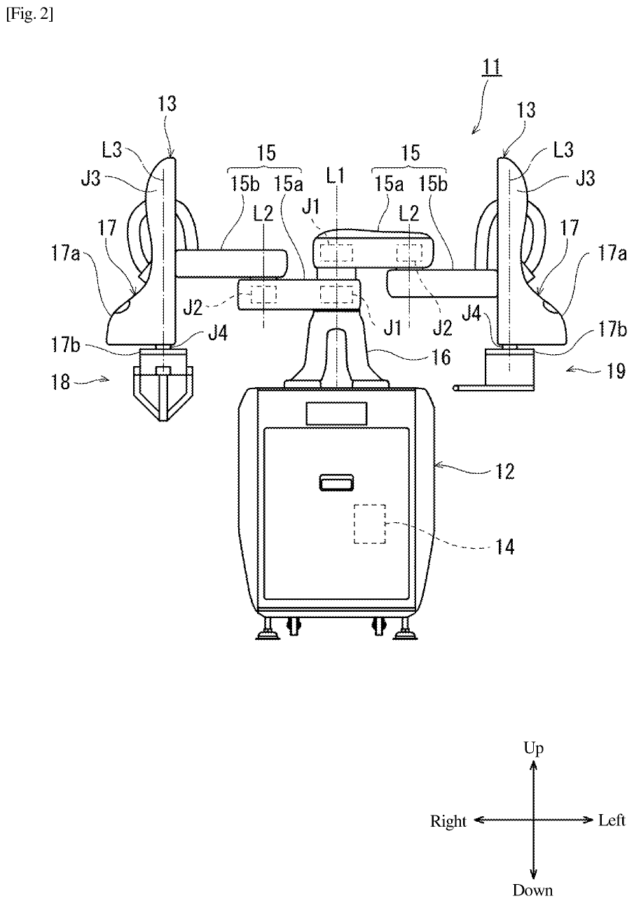

FIG. 2 is a front view schematically illustrating an overall configuration of an example of the robot 11. As illustrated in FIG. 2, the robot 11 includes the base 12 fixed to a carriage, the pair of arms 13, 13 supported by the base 12, and a control device 14 accommodated in the base 12. Each arm 13 is a horizontal articulated robot arm configured to be movable with respect to the base 12. Each arm 13 includes an arm section 15, a wrist section 17, and an end effector (18, 19). The right arm 13 and the left arm 13 may have substantially the same structure. In addition, the right arm 13 and the left arm 13 can be independently operated, or can be operated in conjunction with each other.

In the present example, the arm section 15 is configured of a first link 15a and a second link 15b. The first link 15a is connected to a base shaft 16 fixed to an upper surface of the base 12 by a rotational joint J1, and is rotatable around a rotation axis L1 passing through a shaft center of the base shaft 16. The second link 15b is connected to a distal end of the first link 15a by a rotational joint J2, and is rotatable around a rotation axis L2 defined in the distal end of the first link 15a.

The wrist section 17 is configured of a lift portion 17a and a rotation portion 17b. The lift portion 17a is connected to a distal end of the second link 15b by a linear joint J3, and is movable up and down with respect to the second link 15b. The rotation portion 17b is connected to a lower end of the lift portion 17a by a rotational joint J4, and is rotatable around a rotation axis L3 defined in the lower end of the lift portion 17a.

The end effector (18, 19) is connected to the rotation portion 17b of each of the right and left wrist sections 17. That is, the end effector (18, 19) is provided to a distal end of each of the right and left arms 13.

Each arm 13 having the above-described configuration includes the joints J1 to J4. Then, the arm 13 is provided with a servo motor (not illustrated) for driving, an encoder (not illustrated) for detecting a rotation angle of the servo motor, and the like to correspond to the joints J1 to J4. In addition, the rotation axis L1 of the first links 15a and 15a of two arms 13, 13 are on the same straight line, and the first link 15a of one arm 13 and the first link 15a of the other arm 13 are disposed with a height difference in the up and down direction.

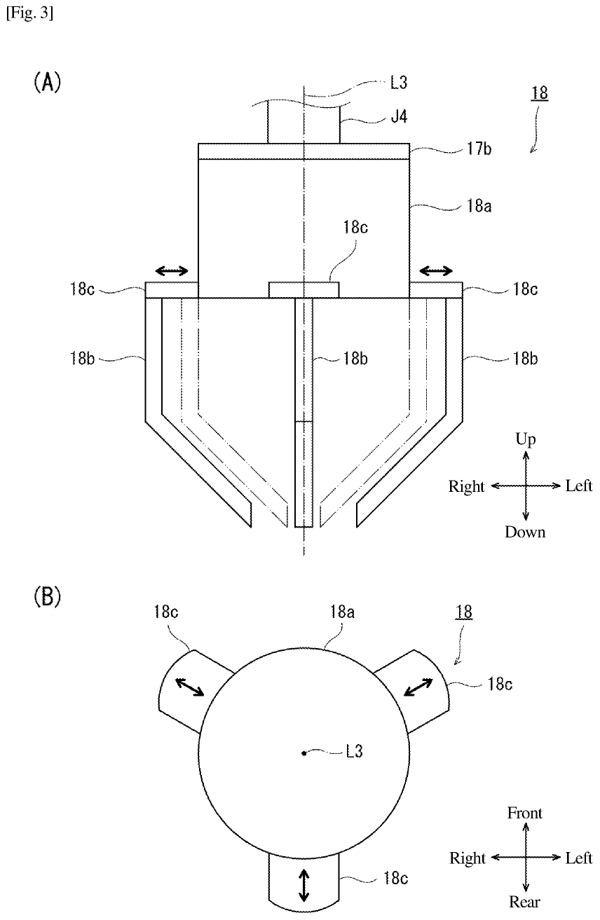

FIG. 3(A) and FIG. 3(B) are a front view and a plan view illustrating a configuration of the end effector (18) provided to the right arm 13. The end effector (18) is a robot hand configured to hold the food 40. Hereinafter, the end effector (18) is referred to as a robot hand 18. The robot hand 18 includes a base portion 18a connected to the rotation portion 17b of the right wrist section 17, three fingers 18b for holding food, and an opening/closing driving device 18c for the finger 18b. Note that, the number fingers 18b may be four or more.

The base portion 18a is formed in a cylindrical shape. The fingers 18b are provided to the outer surface of the lower end of the base portion 18a at a regular interval (for example, an interval of 120 degrees) via the opening/closing driving device 18c. The finger 18b is formed in a rod shape. The lower side of the finger 18b is curved toward a central direction (hereinafter, referred to as a holding direction) of the rotation axis L3 of the base portion 18a. The opening/closing driving device 18c includes an actuator (not illustrated) such as a servo motor therein. By the driving of the actuator, the finger 18b is operated in the holding direction (central direction of the rotation axis L3) and an opening direction which is a direction opposite to the holding direction. The robot hand 18 is configured such that the interval between the lower distal ends of the fingers 18b is closed so that the lower distal ends hold the food 40 (hereinafter, referred to as a holding operation).

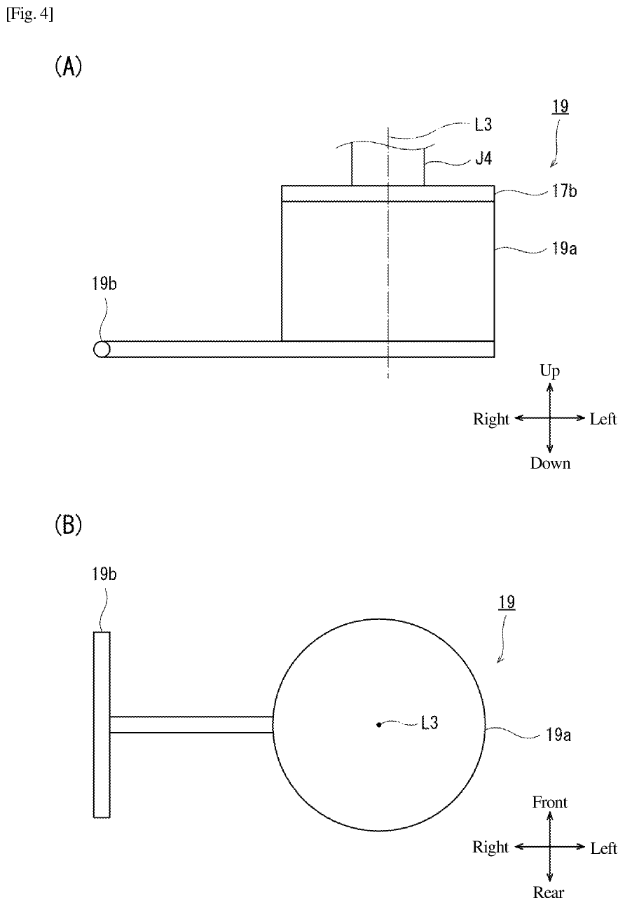

FIG. 4(A) and FIG. 4(B) area front view and a plan view illustrating a configuration of the end effector 19 provided to the left arm 13. As illustrated in FIG. 4, the end effector 19 includes a base portion 19a connected to the rotation portion 17b of the left wrist section 17, and a distal end portion 19b.

The base portion 19a is formed in a cylindrical shape. The distal end portion 19b is provided to a lower end of the base portion 18a. The distal end portion 19b has a T-shape in plan view, and the rod of the distal end extends in the horizontal direction (the front and rear direction in FIG. 4) in the posture of at least one robot 11. As described below, the end effector 19 is configured to support a longitudinal intermediate portion of the food 40 in a state where the food 40 is hung down from the end portion of the robot hand 18. In the present embodiment, the robot 11 is configured to transport the food 40 in a state where the food 40 is held by the robot hand 18 (refer to FIG. 3) of the right arm 13 and the food 40 is supported by the end effector 19 (refer to FIG. 4) of the left arm 13.

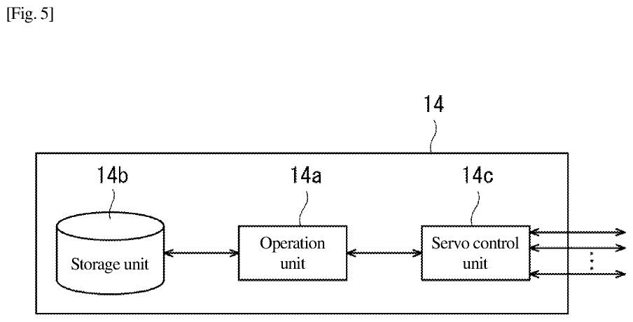

FIG. 5 is a functional block diagram schematically illustrating a configuration of the control device 14 (refer to FIG. 2) of the robot 11. As illustrated in FIG. 5, the control device 14 includes an operation unit 14a such as a CPU, a storage unit 14b such as ROM or RAM, and a servo control unit 14c. The control device 14 is, for example, a robot controller including a computer such as a microcontroller. The control device 14 may be configured of a single control device 14 for centralized control, or may be configured of a plurality of control devices 14 for distributed control in cooperation with each other.

Information such as a basic program as the robot controller and various items of fixed data is stored in the storage unit 14b. The operation unit 14a controls various operations of the robot 11 by reading and executing software such as the basic program stored in the storage unit 14b. That is, the operation unit 14a generates a control command for the robot 11 and outputs the control command to the servo control unit 14c. The servo control unit 14c is configured to control the driving of the servo motor corresponding to the joints J1 to J4 of each arm 13 of the robot 11 on the basis of the control command generated by the operation unit 14a. In addition, the holding operation of the food 40 by the fingers 18b of the robot hand 18 is also controlled by the control device 6. Accordingly, the control device 6 controls the entire operation of the robot 1.

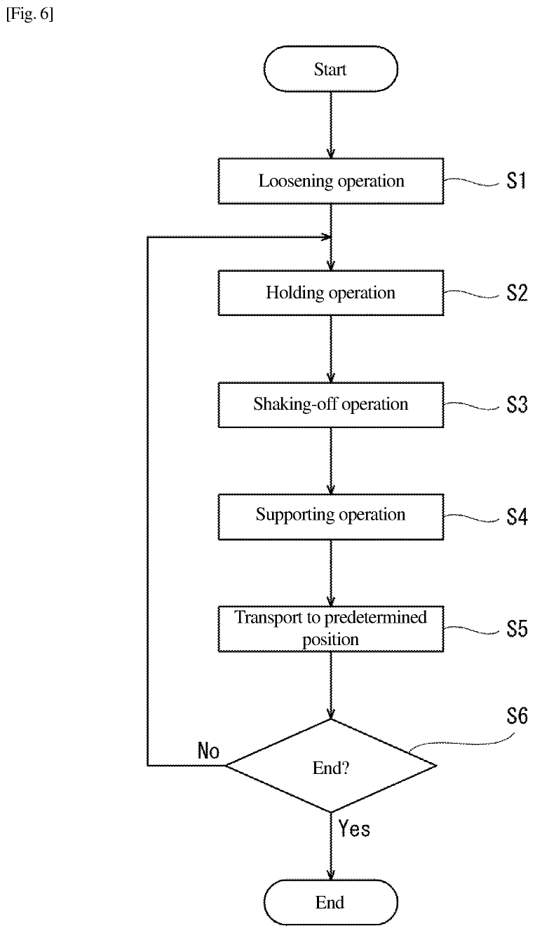

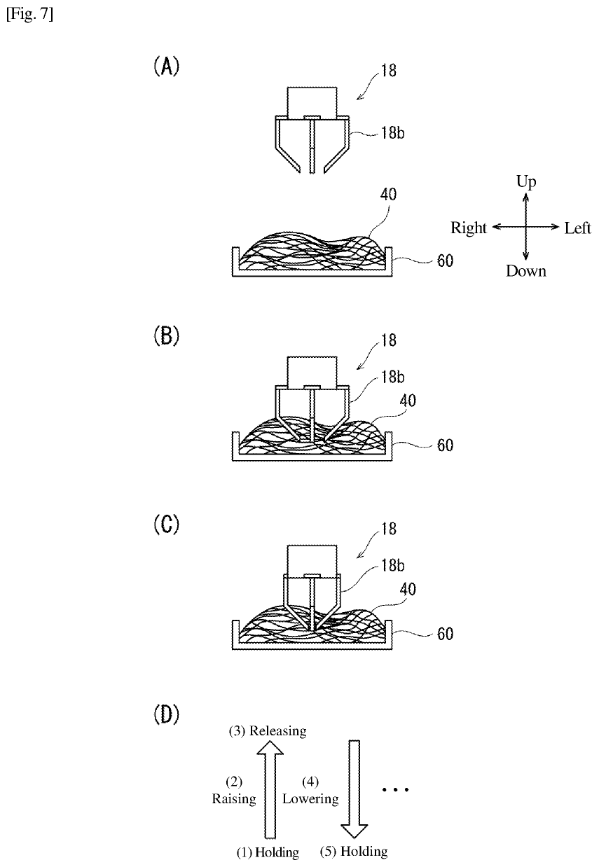

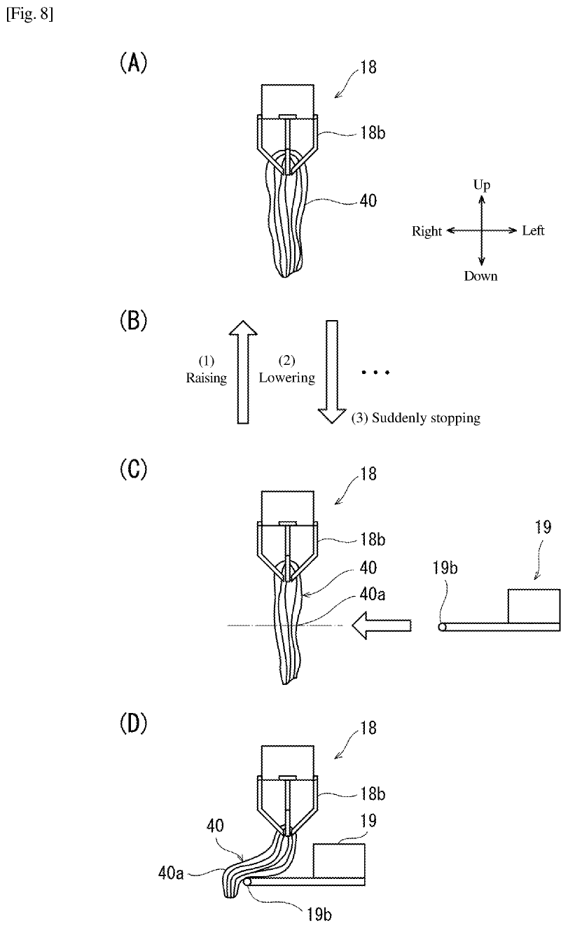

Next, an example of the operation of the robot 11 controlled by the control device 14 will be described using the flowchart of FIG. 6. FIG. 7 and FIG. 8 are schematic views illustrating an example of the operation of the robot.

First, the robot 11 performs a loosening operation of the food 40 prior to the transportation operation of the food 40 (step S1 of FIG. 6). The loosening operation of the food 40 refers to an operation of opening the fingers 18b and dropping the food 40 after holding the food 40 once by the fingers 18b of the robot hand 18. Specifically, by controlling the operation of the right arm 13, as illustrated in FIG. 7(A), the control device 14 moves the robot hand 18 to be in the vicinity just above the tray container 60 in which the food 40 is accommodated. Then, as illustrated in FIG. 7(B) and FIG. 7(C), the control device 14 lowers the robot hand 18 to hold the food 40 accommodated in the tray container 60 once. Thereafter, the control device 14 raises the robot hand 18 and opens the fingers 18b to drop the food 40. As illustrated in FIG. 7(D), (1) a holding operation, (2) a raising operation, (3) an opening operation, (4) a dropping operation, and (5) a holding operation are performed in order. That is, a series of operations of picking up and dropping the pasta (40) in the tray container 60 is repeatedly performed by the robot hand 18, and thereby the pasta (40) can be loosened. The flexibility of the pasta (40) is increased and thus it becomes easy to hold the pasta (40). Note that, the number of times of performing the loosening operation of the food 40 is appropriately set according to the state of the food (40), the ambient temperature environment, and the like.

Next, the robot 11 performs the holding operation of the food 40 again by the robot hand 18 for the transportation (step S2 in FIG. 6). Specifically, by controlling the operation of the right arm 13, the control device 14 lowers the robot hand 18 from the vicinity just above the tray container 60, holds the food 40 by closing the fingers 18b, and raises the robot hand 18 to a predetermined position. Here, since the food 40 is long and flexible pasta, as illustrated in FIG. 8(A), the food 40 held by the robot hand 18 is in a state of being hung down from the end portion of the fingers 18b.

Next, the robot 11 performs a shaking-off operation of the food 40 after the holding operation of the food 40 (step S3 in FIG. 6). Specifically, by controlling the operation of the right arm 13, the control device 14 lowers the robot hand 18, which is holding the food 40 as illustrated in FIG. 8(A), from a state in which the robot hand 18 is raised to a predetermined position, and then suddenly stops the robot hand 18 at a predetermined position (refer to FIG. 8(B)). In this manner, an excessive amount of pasta (40) is shaken off, and thus an appropriate amount of pasta (40) can be held. Note that, the number of times of performing the shaking-off operation of the food 40 is appropriately set according to the amount of pasta (40) corresponding to, for example, one serving.

Next, the robot 11 supports, by the end effector 19, the food 40 held by the robot hand 18 (step S4 in FIG. 6). Specifically, by controlling the operation of the left arm 13, as illustrated in FIG. 8(C), the control device 14 causes the rod-shaped distal end portion 19b, which extends in the horizontal direction (in the front and rear direction in FIG. 8), of the end effector 19 to be operated to cross a longitudinal intermediate portion 40a of the food 40 hung down from the end portion of the robot hand 18 (in the right direction in the same drawing). In this manner, the longitudinal intermediate portion 40a of the food 40 hung down from the end portion of the robot hand 18 is supported by the rod-shaped distal end portion 19b of the end effector 19.

Finally, the robot 11 transports, to a predetermined position, the food 40 in a state where the food 40 is held by the robot hand 18 and the longitudinal intermediate portion 40a of the food 40 is supported by the end effector 19 (step S5 in FIG. 6). Specifically, by controlling the operation of the right and left arms 13, as illustrated in FIG. 8(D), the control device 14 moves the food 40 (in the left direction in the same drawing) while maintaining the state of holding the food 40 by the robot hand 18 and supporting the longitudinal intermediate portion 40a of the food 40 by the end effector 19. In this manner, it is possible to securely transport the food 40 to a predetermined position on the weighing conveyor 51 of the combination weighing device 50 after reducing the dimension of the total length of the food 40 in the up and down direction (refer to FIG. 1). The robot 11 repeats the operations from step S2 to step S5 until the end of the work (step S6 in FIG. 6).

Note that, in the transportation operation of the food 40 in the present embodiment, since the movement amount of the robot arm 13 on the robot hand 18 side in the up and down direction becomes small, it is suitable for a horizontal articulated arm having a short stroke in the up and down direction, such as the robot arm 13 of the present embodiment.

### Modification Example

Note that, the end effector 19 of the present embodiment has a configuration provided with the rod-shaped distal end portion 19b extending in the horizontal direction (the front and rear direction in FIG. 8) in the posture of at least one robot 11, but is not limited to the configuration. Hereinafter, a configuration of a modification example of the end effector 19 will be described.

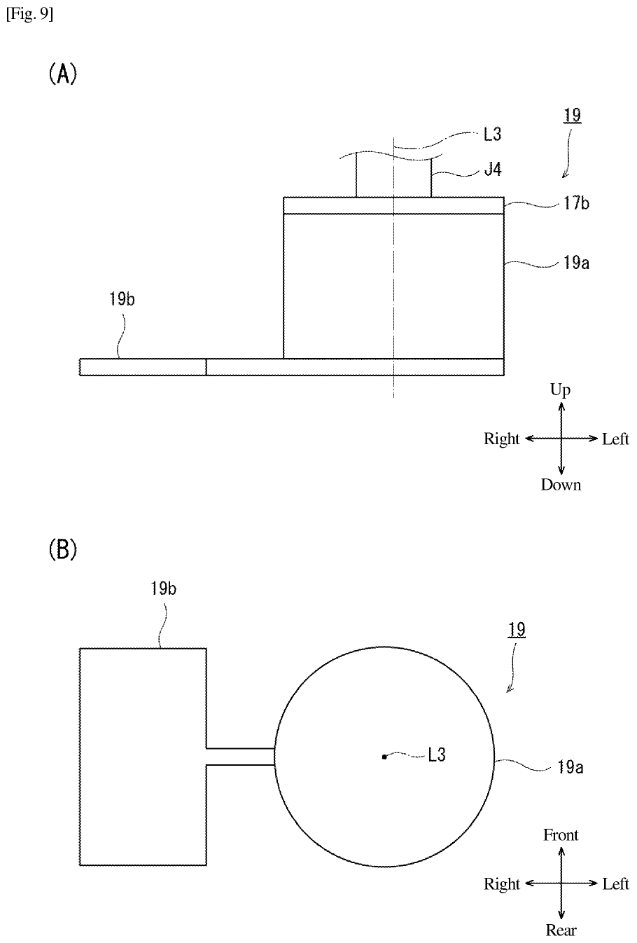

FIG. 9(A) and FIG. 9(B) are a front view and a plan view illustrating a configuration according to a first modification example of the end effector 19 provided to the left arm 13. As illustrated in FIG. 9, the distal end portion 19b of the end effector 19 according to the present modification example has a flat plate shape extending in a horizontal plane (a plane defined in the front and rear direction and the right and left direction in FIG. 9) in the posture of at least one robot 11. According to the present modification example, since the flat-plate-shaped distal end portion 19b of the end effector 19 extends in the horizontal plane, it is possible to support the longitudinal intermediate portion 40a of the food 40 by the distal end portion 19b of the end effector 19 by causing the distal end portion 19b to be operated to cross the longitudinal intermediate portion 40a of the food 40 hung down from the end portion of the robot hand 18 similarly to the above-described embodiment.

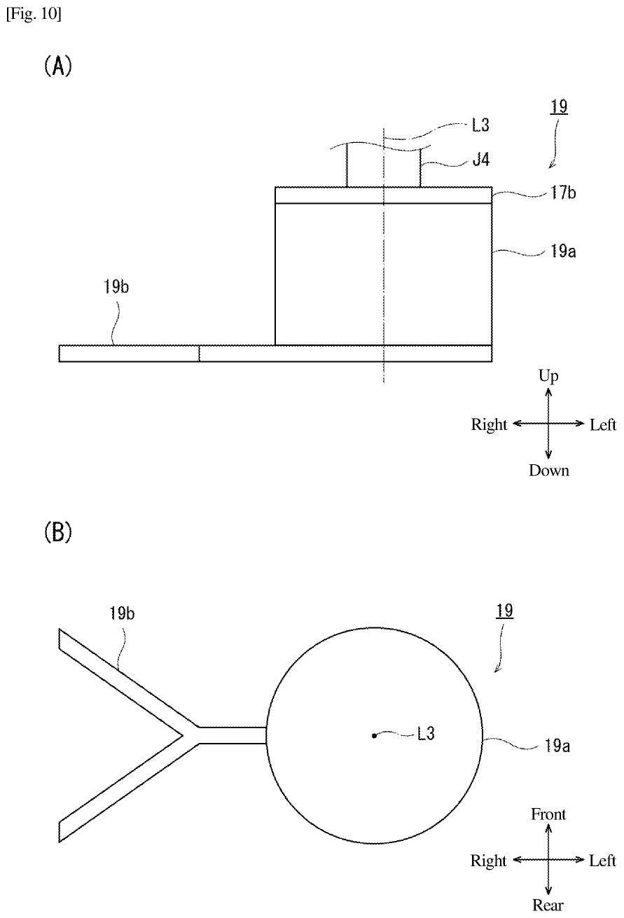

FIG. 10(A) and FIG. 10(B) are a front view and a plan view illustrating a configuration according to a second modification example of the end effector 19 provided to the left arm 13. As illustrated in FIG. 10, the distal end portion 19b of the end effector 19 according to the present modification example has a V-shape in plan view, in the posture of at least one robot 11.

According to the present modification example, since the distal end portion 19b of the end effector 19 has a V-shape, it is possible to support the longitudinal intermediate portion 40a of the food 40 by the distal end portion 19b of the end effector 19 by causing the distal end portion 19b to be operated to cross the longitudinal intermediate portion 40a of the food 40 hung down from the end portion of the robot hand 18 similarly to the above-described embodiment. In addition, it is easy to align the position of the end effector 19 with the center of the food 40. Note that, the V-shape may be a notch.

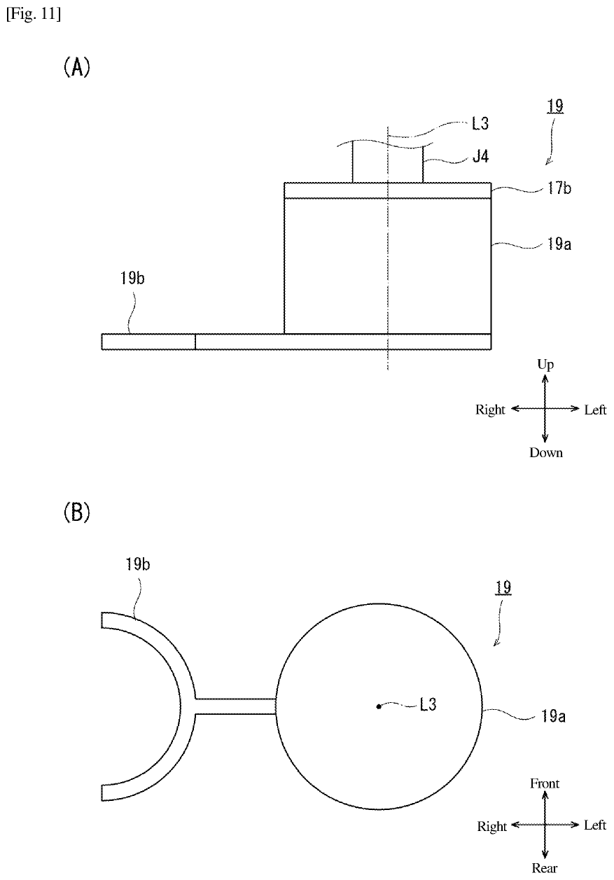

FIG. 11(A) and FIG. 11(B) are a front view and a plan view illustrating a configuration according to a first modification example of the end effector 19 provided to the left arm 13. As illustrated in FIG. 11, the distal end portion 19b of the end effector 19 according to the present modification example has a U-shape in plan view, in the posture of at least one robot 11. According to the present modification example, since the distal end portion 19b of the end effector 19 has a U-shape, it is possible to support the longitudinal intermediate portion 40a of the food 40 by the distal end portion 19b of the end effector 19 by causing the distal end portion 19b to be operated to cross the longitudinal intermediate portion 40a of the food 40 hung down from the end portion of the robot hand 18 similarly to the above-described embodiment. In addition, it is easy to align the position of the end effector 19 with the center of the food 40. Note that, the U-shape may be a notch.

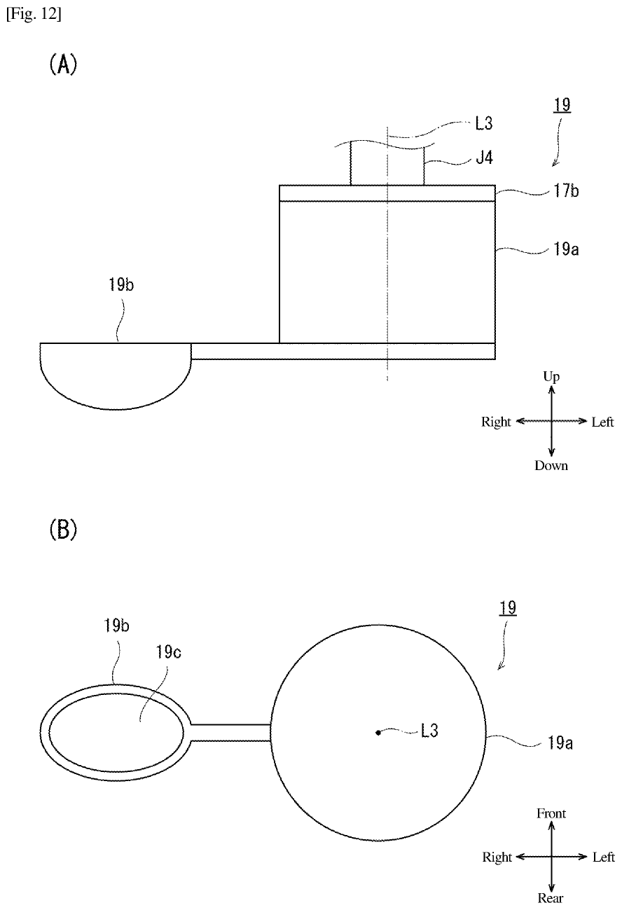

FIG. 12(A) and FIG. 12(B) are a front view and a plan view illustrating a configuration according to a first modification example of the end effector 19 provided to the left arm 13. As illustrated in FIG. 12, the distal end portion 19b of the end effector 19 according to the present modification example has a spoon-shaped distal end portion 19b provided with a recess 19c.

According to the present modification example, since the distal end portion 19b of the end effector 19 has a spoon shape, in a state where the opening of the recess 19c is directed upward, it is possible to support the longitudinal intermediate portion 40a of the food 40 by the recess 19c of the spoon by causing the distal end portion 19b to be operated to cross the longitudinal intermediate portion of the food 40 hung down from the end portion of the robot hand 18 similarly to the above-described embodiment. In addition, the pasta (40) may be transported after the pasta (40) is gathered by rotating the robot hand (18) holding the pasta (40) on the spoon (19) as a person rotates pasta on the spoon by using a fork.

### Other Embodiments

Note that, in the above-described embodiment, the food 40 is pasta, but may be noodle strings such as udon, soba, and ramen as long as the food is long and flexible.

In the above-described embodiment, the transport work of the food is performed by the double arm robot 11, but may be realized by a dedicated apparatus which includes the robot hand 18 and the end effector 19 and can perform positioning control.

The robot 11 of the above-described embodiment is the horizontal articulated double arm robot, but may be a vertical articulated robot.

Many modifications and other embodiments of the present invention are apparent to those skilled in the art from the above description. Accordingly, the above description should be construed as illustrative only and is provided for the purpose of teaching those skilled in the art the best modes for carrying out the present invention. The details of the structures and/or the functions can be substantially changed without departing from the spirit of the present invention.

### INDUSTRIAL APPLICABILITY

The present invention is useful in the production site of long and flexible food such as pasta.

### REFERENCE SIGNS LIST

11 robot
13 robot arm
14 control device
18 end effector (robot hand)
18a base portion
18b finger
19 end effector
19a base portion
19b distal end portion
40 food (pasta)
40a longitudinal intermediate portion of food
50 combination weighing device
51 weighing conveyor
52 transporting conveyor
60 container

1. A robot for transporting food which is long and flexible to a predetermined position, the robot comprising:
a base;
a first robot arm and a second robot arm which are connected to the base;
a robot hand provided to the first robot arm and configured to hold the food;
an end effector provided to the second robot arm; and
a control device configured to control an operation of the first robot arm and the second robot arm, wherein
the end effector is configured to support a longitudinal intermediate portion of the food in a state where the food is hung down from an end portion of the robot hand, and
the control device controls the operation of the first robot arm and the second robot arm to transport the food in a state where the food is held by the robot hand and the longitudinal intermediate portion of the food is supported by the end effector.

2. The robot according to claim 1, wherein
the end effector has a rod-shaped distal end portion extending in a horizontal direction in a posture of at least one robot, and
the rod-shaped distal end portion is operated to cross the longitudinal intermediate portion of the food hung down from the end portion of the robot hand.

3. The robot according to claim 1, wherein
the end effector has a flat-plate-shaped distal end portion extending in a horizontal plane in a posture of at least one robot, and
the flat-plate-shaped distal end portion is operated to cross the longitudinal intermediate portion of the food hung down from the end portion of the robot hand.

4. The robot according to claim 1, wherein
the end effector has a U-shaped or V-shaped distal end portion in plan view in a posture of at least one robot, and
the U-shaped or V-shaped distal end portion is operated to cross the longitudinal intermediate portion of the food hung down from the end portion of the robot hand.

5. The robot according to claim 1, wherein
the end effector has a spoon-shaped distal end portion provided with a recess, and
in a state where an opening of the recess is directed upward in a posture of at least one robot, the spoon-shaped distal end portion is operated to cross the longitudinal intermediate portion of the food hung down from the end portion of the robot hand.

6. The robot according to claim 1, wherein
the robot hand includes
a plurality of fingers configured to hold the food by an interval between lower distal ends being closed, and
an opening/closing driving device configured to operate the plurality of fingers in a holding direction and an opening direction which is a direction opposite to the holding direction,
a food loosening operation of opening the plurality of fingers and dropping the food is performed after the food is held by the plurality of fingers, and the food is transported after the food loosening operation.

7. The robot according to claim 1, wherein the robot hand is lowered after a holding operation of the food, and then is suddenly stopped.

8. A method for operating a robot including a base, a first robot arm and a second robot arm which are connected to the base, a robot hand provided to the first robot arm and configured to hold a food, an end effector provided to the second robot arm, and a control device configured to control an operation of the first robot arm and the second robot arm, the method comprising:
holding the food which is long and flexible by the robot hand;
supporting a longitudinal intermediate portion of the food in a state where the food is hung down from an end portion of the robot hand, by the end effector; and
transporting the food to a predetermined position in a state where the food is held by the robot hand and the longitudinal intermediate portion of the food is supported by the end effector.

9. The robot according to claim 2, wherein
the robot hand includes
a plurality of fingers configured to hold the food by an interval between lower distal ends being closed, and
an opening/closing driving device configured to operate the plurality of fingers in a holding direction and an opening direction which is a direction opposite to the holding direction,
a food loosening operation of opening the plurality of fingers and dropping the food is performed after the food is held by the plurality of fingers, and the food is transported after the food loosening operation.

10. The robot according to claim 3, wherein
the robot hand includes
a plurality of fingers configured to hold the food by an interval between lower distal ends being closed, and
an opening/closing driving device configured to operate the plurality of fingers in a holding direction and an opening direction which is a direction opposite to the holding direction,
a food loosening operation of opening the plurality of fingers and dropping the food is performed after the food is held by the plurality of fingers, and the food is transported after the food loosening operation.

11. The robot according to claim 4, wherein
the robot hand includes
a plurality of fingers configured to hold the food by an interval between lower distal ends being closed, and
an opening/closing driving device configured to operate the plurality of fingers in a holding direction and an opening direction which is a direction opposite to the holding direction,
a food loosening operation of opening the plurality of fingers and dropping the food is performed after the food is held by the plurality of fingers, and the food is transported after the food loosening operation.

12. The robot according to claim 5, wherein
the robot hand includes
a plurality of fingers configured to hold the food by an interval between lower distal ends being closed, and
an opening/closing driving device configured to operate the plurality of fingers in a holding direction and an opening direction which is a direction opposite to the holding direction,
a food loosening operation of opening the plurality of fingers and dropping the food is performed after the food is held by the plurality of fingers, and the food is transported after the food loosening operation.

13. The robot according to claim 2, wherein the robot hand is lowered after a holding operation of the food, and then is suddenly stopped.

14. The robot according to claim 3, wherein the robot hand is lowered after a holding operation of the food, and then is suddenly stopped.

15. The robot according to claim 4, wherein the robot hand is lowered after a holding operation of the food, and then is suddenly stopped.

16. The robot according to claim 5, wherein the robot hand is lowered after a holding operation of the food, and then is suddenly stopped.

17. The robot according to claim 6, wherein the robot hand is lowered after a holding operation of the food, and then is suddenly stopped.
